(19) United States
(12) Patent Application Publication
(10) Pub. No.: US 2007/0121811 A1
(43) Pub. Date: May 31, 2007

(54) Method for opt-in voice session recording in a communication device

(75) Inventors: Goangshiuan Shawn Ying, Oakland, CA (US); Eugene L. Edmon, Danville, CA (US); Steve Aspell, Brentwood, CA (US); Kent G. McCammon, Livermore, CA (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/283,336

(22) Filed: Nov. 18, 2005

(51) Int. Cl. H04M 1/64

(52) U.S. Cl. 379/68

(57) ABSTRACT

A system and method are disclosed for an opt-in voice session recording in a communication device. A system that incorporates teachings of the present disclosure may include, for example, a communication device (200) having a transceiver (102) for communicating with a second communication device, an audio system (206) for exchanging audible signals with an end user of the communication device, and a controller (214) for managing operations of the transceiver and the audio system. The controller can be programmed to establish (304) a voice session with the second communication device, transmit (308) to the second communication device a request to record the voice session, receive (316) from the second communication device a grant to record the voice session, and record (320) the voice session in response to the grant. Additional embodiments are disclosed.

### FIELD OF THE DISCLOSURE

The present disclosure relates generally to communication devices, and more specifically to a method for opt-in voice session recording in a communication device.

### BACKGROUND

Consumers today generally have no convenient way to record a phone conversation while the conversation is taking place. Privacy issues have in large part hindered manufactures from improving telephonic technology in this area.

### BRIEF DESCRIPTION OF THE DRAWINGS

FIG. 1 is a block diagram of a plurality of communication devices operating in a communication system according to teachings of the present disclosure;

FIG. 2 depicts a block diagram of the communication devices according to teachings of the present disclosure;

FIG. 3-4 depict a flowchart of a method operating in any one of the communication devices of the communication system according to teachings of the present disclosure; and

FIG. 5 is a diagrammatic representation of a machine in the form of a computer system within which a set of instructions, when executed, may cause the machine to perform any one or more of the methodologies discussed herein.

### DETAILED DESCRIPTION

Embodiments in accordance with the present disclosure provide a method for opt-in voice session recording in a communication device.

In a first embodiment of the present disclosure, a communication device has a transceiver for communicating with a second communication device, an audio system for exchanging audible signals with an end user of the communication device, and a controller for managing operations of the transceiver and the audio system. The controller can be programmed to establish a voice session with the second communication device, transmit to the second communication device a request to record the voice session, receive from the second communication device a grant to record the voice session, and record the voice session in response to the grant.

In a second embodiment of the present disclosure, a computer-readable storage medium has computer instructions for recording a voice session between the first communication device and a second communication in response to a grant to record received from the second communication device.

In a third embodiment of the present disclosure, a method operates in a first communication device according to the steps of communicating to an end user of a second communication device an option to grant recording of a voice session between the first and second communication devices, and recording the voice session in response to a grant received from the second communication device.

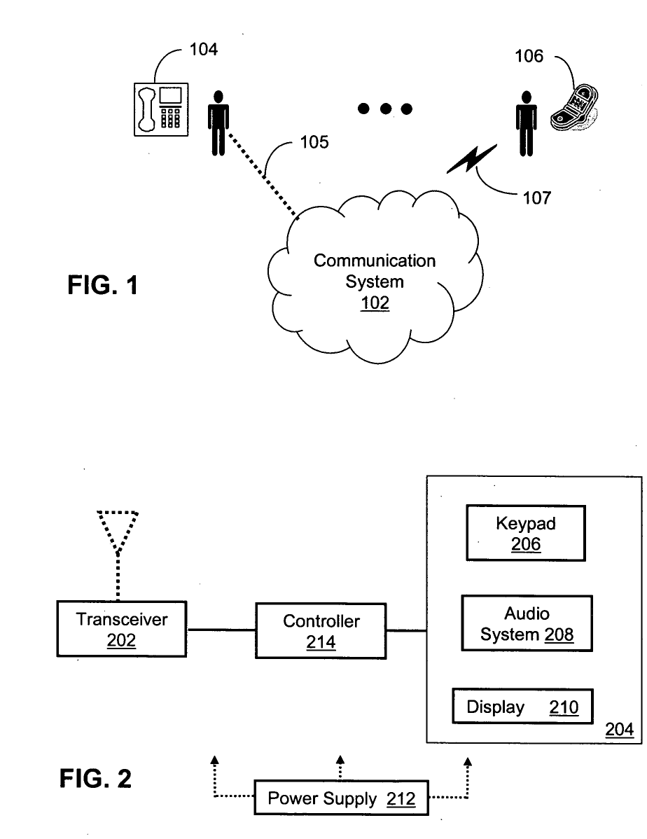

FIG. 1 is a block diagram 100 of a plurality of communication devices 104, 106 operating in a communication system 102 according to teachings of the present disclosure. Communication device 104, for example, can represent a wireline telephony device capable of circuit-switched communications such as POTS (Plain Old Telephone Service) over a wireline communication medium 105. Alternatively, communication device 104 can represent a wireline telephony device capable of packet-switched communications such as VoIP (Voice over Internet Protocol). In another embodiment, communication device 104 can be a cordless phone having a base unit coupled to the wireline medium 105 for supporting either of POTS or VoIP services.

Communication device 106 can represent a wireless telephony device such as a cellular phone, multimode mode wireless phone, or other wireless communication device. Communication device 106 can thus support any of the common wireless technologies existing today or in a next generation such as cellular (e.g., GSM, GSM-GPRS, CDMA, CDMA-1X, EVDO, UMTS, etc.), WiFi, WiMax, Bluetooth™, or software defined radio (SDR), just to mention a few. The communication system 102 can be a hybrid communication system supporting combinations of the wireless and wireline communication technologies mentioned above.

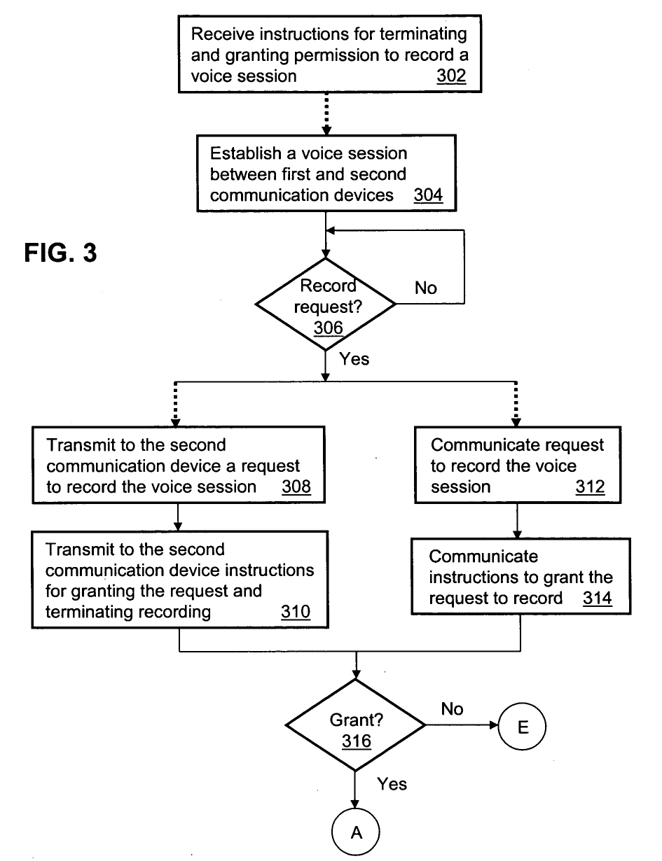

FIG. 2 depicts a block diagram 200 of the communication devices 104 or 106 according to teachings of the present disclosure. The communication devices 104, 106 can each comprise a transceiver 202, a user interface (UI) element 204, and a controller 214 for controlling operations thereof. The transceiver 202 can use common technology for wireline or wireless communications to support the aforementioned technologies depending on the embodiment of the communication device.

The UI element 204 can include among other things common technology such as a keypad 206 (with, for example, depressible buttons and a navigation disk), an audio system 208 for exchanging audio messages with an end user, and a display 210 such as an LCD (Liquid Crystal Display) for conveying images to the end user. Each of components 206-210 can serve as a user interface for manipulating selectable options provided by the communication device 104, 106 and for conveying messages to the end user according to the present disclosure. The controller 214 can include a computing device such as a microprocessor, or digital signal processor (DSP) with associated storage devices such as RAM, ROM, DRAM, Flash, and other common memories. For portable or cordless applications, the communication device 104, 106 can also include a power supply 212 with technology for supplying energy to the components 202-214 of the communication device from one or more rechargeable batteries, and for recharging said batteries.

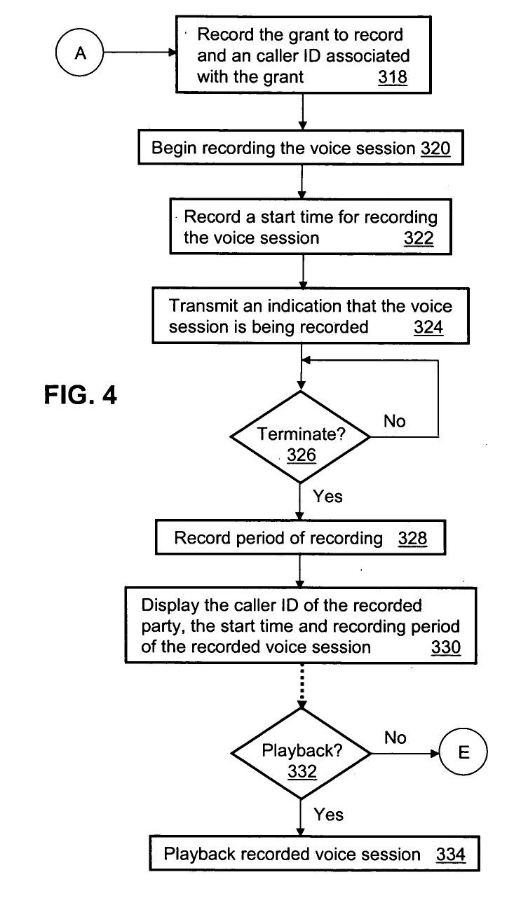

FIGS. 3-4 depict a flowchart of a method 300 operating in any one of the communication devices 104, 106 according to teachings of the present disclosure. Method 300 will be described within the context of recording voice messages exchanged between end users of first and second communication devices. As a point reference, method 300 will be described according to operations taking place in large part in the first communication device. For convenience also, the first communication device will be represented by communication device 104, while the second communication device will be represent by communication device 106. It will be appreciated that any combination of communication devices can be applied to the present disclosure (e.g., cell phone to cell phone, POTS to cell phone, VoIP to POTS, POTS to POTS, and so on).

Method 300 thus begins with step 302 where the controller 214 of the first communication device 104 receives instructions for terminating and granting permission to record a voice session when it takes place with other communication devices. This step can represent a provisioning step in which the end user of the first communication device 104 establishes a procedure so that an end user of the second communication device 106 can grant permission to record a voice session taking place therebetween. A grant can be represented by, for example, a combination of DTMF (Dual Tone Multi Frequency) keypad depressions (e.g., “#*8”), or a voice command (e.g., “I grant recording”) of the end user of the second communication device 106, or a digital signature generated by the second communication device 106 from a trusted source (e.g., Verisign™). The instructions for terminating a recording of the voice session can be the same or a different keypad entry sequence, or a voice command such as, “Terminate recording”.

To support voice triggered recordings, the controller 214 of the first communication device 104 can operate common software applications to recognize voice patterns (such as those noted above) as well as for generating synthesized speech. It should also be noted that step 302 can take place at any time and not necessarily near in time to when a voice session is established (thus the reason for the dashed arrow directed at step 304).

In step 304, the controller 214 can be programmed to establish a voice session between the first and second communication devices 104, 106. The voice session can be initiated by either device. That is, the end user of the second communication device 106 can initiate by keypad 206 manipulations a circuit-switched call (e.g., over a cellular voice channel) or a packet-switched call (e.g., VoIP over a data channel such as GPRS) to first communication device 104. Alternatively, the end use of the first communication device 104 can take similar action to establish a call with the end user of the second communication device 106.

Once a voice session has been established between said communication devices 104, 106, the controller 214 of the first communication device 104 proceeds to step 306 where it checks for a request to record the voice session. The request can come from the end user of the first communication device 104 manipulating a function of keypad 206 (e.g., a 1 second depression of a side key). While the controller 214 is waiting to detect a request to record, the voice session between the first and second communication devices 104, 106 proceeds unrecorded.

Upon detecting a request to record from the end user of the first communication device 104, the controller 214 proceeds to one of two possible embodiments represented by steps 308-310, and 312-314, respectively. In a first embodiment, the controller 214 can proceed to step 308 where it transmits to the second communication device 106 a request to record the voice session. The controller 214 can also proceed to step 310 where it transmits the instructions established in step 302 for terminating and granting the request to record. The controller 214 can be programmed to present the request and the accompanying instructions by way of synthesized voice message, or as a text message which can be conveyed by display 210 of the second communication device 106. Although shown separately, steps 308 and 310 can be integrated into one step in which the request includes the instructions.

Alternatively, the end user of the first communication device 104 can verbally communication in steps 312 and 314 the request to record along with instructions to the end user of the second communication device 106. Once the end user of the second communication device understands these instructions, s/he can grant the request or reject it. The controller 214 can be programmed to detect said grant or rejection in step 316. The grant as noted earlier can be communicated by any means such as, for example, a combination of keypad depressions, a verbal command, or digital signature.

To avoid a fraudulent grant, the controller 214 can be programmed to accept grants only from the end user of the second communication device 106, and reject any emulations of said grant from the first communication device 104. If the end user of the second communication device 106 submits a rejection, the controller 214 ceases to perform the steps to initiate a recording, and thus the voice session continues unrecorded. No response from the end user can also correspond to a rejection. If, on the other hand, a grant is submitted by the end user of the second communication device 106, the controller 214 proceeds to step 318 of FIG. 4.

In step 318, the controller 214 records the grant supplied by the end user of the second communication device 106 (i.e., the sequence of keypad depressions, verbal command, or digital signature). The controller 214 can be further programmed to record the caller identification (ID) of the end user of the second communication device 106 if available as a means for further identification. To avoid violating privacy rights, this step can serve as proof that the end user of the second communication device 106 consented to the recording.

In step 320 the controller 214 begins to record the voice session, and records in step 322 a start time for recording process. In step 324, the controller 214 transmits to the second communication device 106 an indication that the voice session is being recorded. The indication can be an audible notification conveyed according to any method. For example, the controller 214 can be programmed to periodically transmit during the voice session a low volume chirp or beep sound (e.g., every 15 seconds). This chirp or beep reminds the parties that the voice session is being recorded. Moreover, the controller 214 can be programmed so that said indication cannot be disabled by either of the end users of the first and second communication devices 104, 106 until recording is terminated in step 326. Alternatively, the second communication device 106 can be programmed so that after the grant is submitted it emits the beep or chip just described until the recording session is terminated in step 326. Either of the communication devices 104, 106 can also emit light or another form of notification for its users to recognize a recording session in progress.

In step 326, the controller 214 checks for a request to terminate the recording session. Termination can occur according to any number of embodiments. For example, the end user of the second communication device 104 can submit a termination request according to the termination instructions given thereto in steps 310 or 314. Termination can be triggered, for example, by the same keypad sequence to start the recording process, or a different keypad sequence. Termination can alternatively be invoked by a voice command. In yet another embodiment, the end user of the first communication device 104 can terminate the recording process by a keypad depression or other means to manipulate operations of the first communication device 104. Alternatively, the first communication device 104 can terminate the recording process automatically when the voice session is terminated by either party.

The controller 214 will continue to record the voice session until a termination request is detected in step 326. Upon detecting a termination request, the controller 214 proceeds to step 328 where it records the recording period, which can be measured by the difference between the termination time and the start time recorded in step 322. In step 330, the controller 214 can display to the end user of the first communication device 104 the caller ID of the recorded party, the start time and recording period of the recorded voice session.

At any time thereafter, the controller 214 can be directed in step 332 by the end user of the first communication device 104 by way of one or more manipulations of keypad 206 to playback the recorded message. In step 334, the controller 214 playbacks the recorded message by way of audio system 208 as many times as the end user may desire. Step 332 can be represented by a selection of playback commands such as play, pause, forward, rewind, and accelerated version of these functions. These commands can be displayed graphically by way of display 210 as soft keys or other suitable representations.

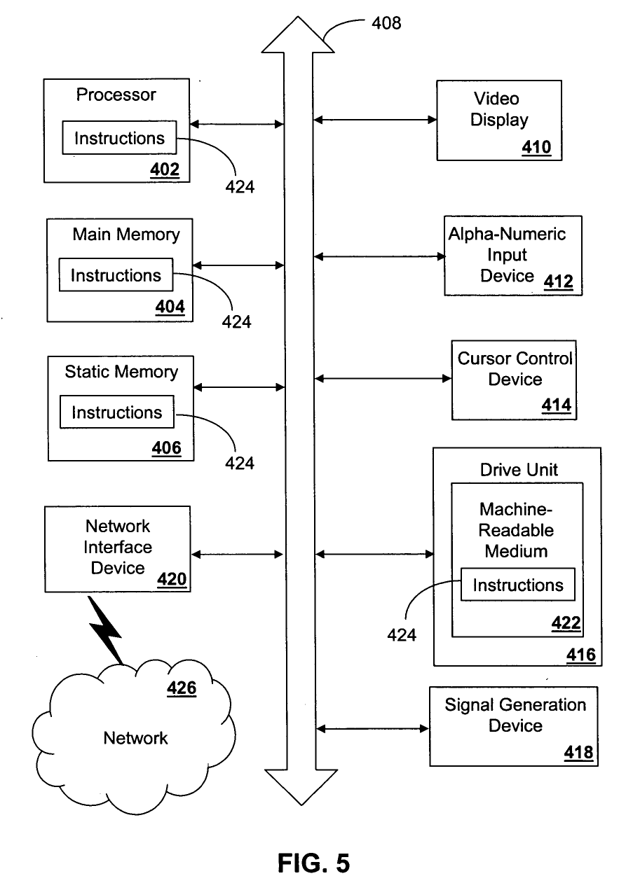

FIG. 5 is a diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A communication device, comprising:
a controller for managing operations of a transceiver and an audio system, programmed to:
establish a voice session with a second communication device;
transmit to the second communication device a request to record the voice session;
receive from the second communication device a grant to record the voice session; and
record a portion of the voice session in response to the grant.

2. The communication device of claim 1, comprising an input interface, wherein the controller is programmed to receive from the input interface a request to record the voice session.

3. The communication device of claim 1, wherein the controller is programmed to:
transmit to the second communication device instructions for granting permission to record the voice session; and
receive from the second communication device the grant to record the voice session in accordance with the grant instructions.

4. The communication device of claim 1, comprising an input interface, wherein the controller is programmed to receive from the input interface instructions for granting permission to record the voice session with the second communication device.

5. The communication device of claim 1, wherein the controller is programmed to:
transmit to the second communication device an audible indication that the voice session is being recorded; and
disable the audible indication only after termination of said recording.

6. The communication device of claim 1, wherein the controller is programmed to:
transmit to the second communication device instructions for terminating recording of the voice session;
receive from the second communication device a request to terminate recording of the voice session in accordance with the termination instructions; and
terminate recording of the voice session in response to the termination request.

7. The communication device of claim 1, comprising an input interface, wherein the controller is programmed to:
receive from the input interface a request from an end user of the communication device to terminate recording of the voice session; and
terminate recording of the voice session in response to the termination request.

8. The communication device of claim 1, wherein the controller is programmed to process the voice session over at least one among a wireless communication medium, and a wireline communication medium, and wherein the voice session comprises one among a packet-switched voice session, and a circuit-switched voice session.

9. The communication device of claim 1, comprising a display, wherein the controller is programmed to:
record at least one among a start time to record, a recording period for the voice session, and an identification of a party submitting the grant;
display at least one among the start time to record, the recording period for the voice session, and the identification of a party submitting the grant;
receive a request to playback a portion of the recorded voice session; and
generate audible signals corresponding to the requested portion of the recorded voice session.

10. In a first communication device a computer-readable storage medium, comprising computer instructions for recording a voice session between the first communication device and a second communication in response to a grant to record received from the second communication device.

11. The storage medium of claim 10, comprising computer instructions for:
receiving a request from an end user of the first communication device to record the voice session with the second communication device; and
transmitting the request to record to the second communication device.

12. The storage medium of claim 10, comprising computer instructions for:
transmitting to the second communication device instructions for granting permission to record the voice session; and
receiving from the second communication device the grant to record the voice session in accordance with the grant instructions.

13. The storage medium of claim 10, comprising computer instructions for transmitting to the second communication device an indication that the voice session is being recorded.

14. The storage medium of claim 10, comprising computer instructions for:
transmitting to the second communication device instructions for terminating recording of the voice session;
receiving from the second communication device a request to terminate recording of the voice session in accordance with the termination instructions; and
terminating recording of the voice session in response to the termination request.

15. The storage medium of claim 10, comprising computer instructions for:
receiving a request from an end user of the first communication device to terminate recording of the voice session; and
terminating recording of the voice session in response to the termination request.

16. The storage medium of claim 10, comprising computer instructions for processing the voice session over one among a wireless communication medium, and a wireline communication medium.

17. The storage medium of claim 10, comprising computer instructions for recording the grant to record and an identification of a party submitting the grant.

18. The storage medium of claim 10, comprising computer instructions for:
recording at least one among a start time to record, a recording period for the voice session, and an identification of a party submitting the grant;
conveying to an end user of the first communication device at least one among the start time to record, the recording period for the voice session, and the identification of a party submitting the grant;
receiving a request from the end user to playback a portion of the recorded voice session; and
playing back the requested portion of the recorded voice session.

19. In a first communication device, a method comprising the steps of:
communicating to an end user of a second communication device an option to grant recording of a voice session between the first and second communication devices; and
recording the voice session in response to a grant received from the second communication device.

20. The method of claim 19, wherein the grant is a digital signature.
